(19) United States
(12) Patent Application Publication
(10) Pub. No.: US 2026/0012483 A1
(43) Pub. Date: Jan. 8, 2026

(54) ELECTRONIC MESSAGE VERIFICATION INFRASTRUCTURE

(71) Applicant: FTECH SYSTEMS LTD., Limassol (CY)

(72) Inventor: Alexandru Marian Ciobanu, Limassol (CY)

(21) Appl. No.: 18/763,310

(22) Filed: Jul. 3, 2024

(51) Int. Cl. H04L 9/40

(52) U.S. Cl. CPC H04L 63/1483; H04L 63/102

(57) ABSTRACT

Briefly, example methods, apparatuses, and/or articles of manufacture are disclosed that may be implemented, in whole or in part, using one or more computing devices to facilitate and/or support one or more operations and/or techniques for an infrastructure for electronic message verification, such as implemented in connection with one or more computing and/or communication networks and/or protocols.

### FIELD

The present disclosure relates generally to computer and/or electronic infrastructures and, more particularly, to infrastructure for electronic message verification, such as implemented via one or more communications networks and/or protocols.

### BACKGROUND

Cybersecurity breaches (e.g., on-line attacks) often involve social engineering. These or like attacks may rely on human deception, where an individual is asked to complete a task following an electronic message or like interaction with a legitimate person or service. As these or like attacks continue to grow in complexity, it may become increasingly difficult for individuals to identify and/or remedy such attacks.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating features of an example operating environment for infrastructure for electronic message verification, according to an implementation.

FIG. 2 is a flow diagram illustrating an implementation of an example process that may be performed, in whole or in part, to facilitate and/or support one or more operations and/or techniques for infrastructure for electronic message verification.

FIG. 3 is a flow diagram illustrating an implementation of an example process that may be performed, in whole or in part, to facilitate and/or support one or more operations and/or techniques for infrastructure for electronic message verification.

FIG. 4 is a flow diagram illustrating an implementation of an example process that may be performed, in whole or in part, to facilitate and/or support one or more operations and/or techniques for infrastructure for electronic message verification.

FIG. 5 is a flow diagram illustrating an implementation of an example process that may be performed, in whole or in part, to facilitate and/or support one or more operations and/or techniques for infrastructure for electronic message verification.

FIG. 6 is a flow diagram illustrating an implementation of an example process that may be performed, in whole or in part, to facilitate and/or support one or more operations and/or techniques for infrastructure for electronic message verification.

FIG. 7 is a flow diagram illustrating an implementation of an example process that may be performed, in whole or in part, to facilitate and/or support one or more operations and/or techniques for infrastructure for electronic message verification.

FIG. 8 is a schematic diagram illustrating an example system embodiment of a network-connected device providing aspects of infrastructure for electronic message verification, according to an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular example, implementation and/or embodiment is included in at least one example, implementation and/or embodiment of claimed subject matter. Thus, appearances of such phrases, for example, in various places throughout this specification are not necessarily intended to refer to the same implementation and/or embodiment and/or to any one particular implementation and/or embodiment. Furthermore, it is to be understood that particular features, structures, characteristics, and/or the like described are capable of being combined in various ways in one or more implementations and/or embodiments and, therefore, are within intended claim scope. Unless explicitly indicated to the contrary, reference to “another example” and/or “a further example” does not indicate that the described example is an exclusive alternative to a preceding example. In general, such examples may be alternatives to and/or additions to previous examples. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

Some example methods, apparatuses, and/or articles of manufacture are disclosed herein that may be used, in whole or in part, to facilitate and/or support one or more operations and/or techniques for infrastructure for electronic message (“e-message”) verification. As will be seen, particular examples may include implementing and/or using one or more computing and/or communications platforms for verification of an e-message via a process that, in some instances, may be based, at least in part, on digital content indicative of the e-message.

By way of illustration, at times, a host e-message verification application may, for example, be deployed to an organization's membership (e.g., installed on member's user devices such as mobile phones). As such, the host application may, for example, provide an electronic interface (e.g., a GUI) that may be used, in whole or in part, to facilitate various verification request types.

For example, as will also be seen, in some instances, the host application may provide an interface to request an external-type verification process, where an e-message (e.g., a request to transfer funds, provide credentials, etc. . . . ) that purports to be from persons and/or services from outside an organization may be verified. In some implementations, external verification may include, for example, providing requisite content to a verifier entity that may be external to the user's organization (e.g., a dedicated and/or trained cybersecurity platform) that may, for example, determine the legitimacy of the e-message being verified.

As a further example, the host application may, for example, also provide an interface to request an internal-type verification process, where an e-message that purports to be from another member of the user's organization may be verified. In some implementations, the internal-type verification may include, for example, one or more electronic interactions with one or more internal entities, so as to verify the legitimacy of the e-message. For example, one or more internal entities may verify the legitimacy of the e-message via their own instance of the host verification application, such as deployed on their respective user devices, or the like.

In some implementations, as also discussed in greater detail below, a verification process may, for example, prompt a particular verification requester to provide requisite digital content, such as, for example, a digital image (e.g., an electronic picture, etc.) of the e-message being verified, an audio recording of an e-message being verified, an on-screen narrative pertaining to the e-message, or the like. This or like digital content may, for example, be communicated, such as via one or more communications networks and/or protocols, to the verifying entity for verification. For instance, providing an image, recording, narrative, etc. may, for example, prevent further on-line interactions with the e-message being verified (e.g., from accidentally enabling a successful attack), or the like.

In one or more further implementations, the host e-message verification application may, for example, provide a suitable interface to a group messaging channel, such as a more secure channel external to the organization's one or more networks (e.g., the group messaging channel may, for example, be hosted externally to the organization's network(s)). In some implementations, the group messaging channel may be used, in whole or in part, to electronically disseminate timely security alerts and/or like notifications, such as fraud alerts, or the like, in response to a malicious e-message detected via an e-message verification process, for example. In one or more further implementations, the group messaging channel may, for example, provide a more secure communication channel for the organization's membership, for instance, to provide a more secure communication channel in the event of the organization's network infrastructure being compromised. In still one or more further implementations, the group messaging channel may, for example, facilitate and/or support (peer-to-peer (P2P) communications, such as, for example, via a more secure communication functionality. As such, in some implementations, the group messaging channel may, for example, provide a more secure communication channel, such as in the event of the organization's network infrastructure being compromised.

In this context, “digital content” refers to signals, such signal packets, for example, and/or states, such as physical states on a memory device, for example, but otherwise is employed in a manner irrespective of format, such as any expression, representation, realization, and/or communication, for example. Digital content may comprise, for example, any information, knowledge, and/or experience, such as, again, in the form of signals and/or states, physical and/or otherwise. Digital content may, for example, include content in a form that although not necessarily capable of being perceived by a human, (e.g., via human senses, etc.) but that may nonetheless be transformed into a form capable of being so perceived, such as visually, haptically, and/or audibly, for example. Non-limiting examples may include text, audio, images, video, combinations there-of, or the like. “Presenting” digital content refers to making content available in a perceptible form. Non-limiting examples may include displaying content on a display device, playing audio content on speakers, actuating haptic devices, combinations thereof, or the like.

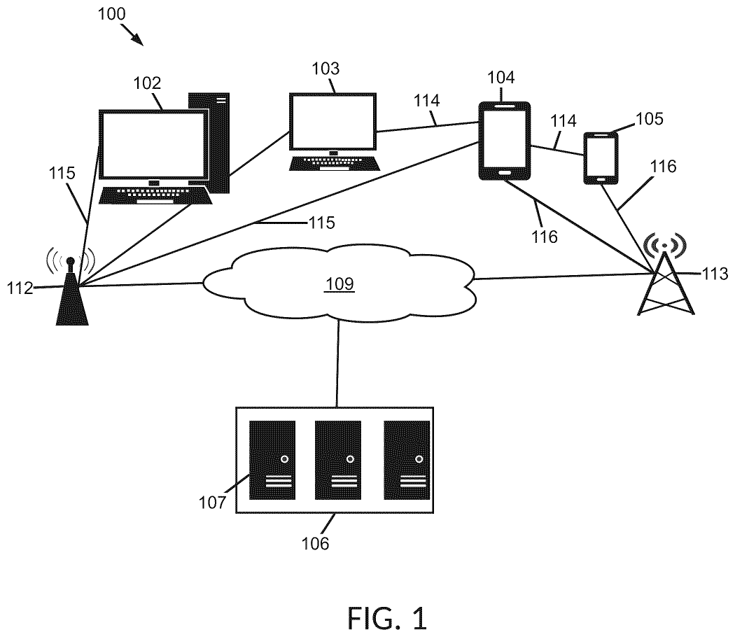

FIG. 1 is a schematic diagram illustrating features associated with an implementation of an example operating environment 100 capable of facilitating and/or supporting one or more platforms and/or techniques for infrastructure for electronic message verification. It should be appreciated that operating environment 100 is described herein as a non-limiting example that may be implemented, in whole or in part, in the context of various wired and/or wireless communications networks, and/or any suitable portion and/or combination of such networks. For example, these or like networks may include one or more public networks (e.g., the Internet, the World Wide Web), private networks (e.g., intranets), wireless wide area networks (WWAN), wireless local area networks (WLAN, etc.), wireless personal area networks (WPAN), telephone networks, cable television networks, Internet access networks, fiber-optic communication networks, waveguide communication networks, or the like. It should also be noted that claimed subject matter is not limited to a particular network and/or operating environment.

The example environment 100 includes a plurality of user devices 102, 103, 104, 105, including a personal computer (PC) 102, laptop computer 103, tablet device 104, and smartphone 105. Other user devices may include personal digital assistants (PDAs), personal audio and/or video devices, personal navigation devices, or the like. Additionally, such user devices may be virtualized devices residing on another computing infrastructure, such as a data center comprising a plurality of servers. These devices are connected to a public network 109, such as the Internet. Such connections may include local connections 115 to an access point 112 that provides a routed connection to the Internet 109. For example, wireless connections 115 may be implemented according to one of the 802.11 wireless networking protocols. Other such connections may include cellular network connections 1116 that provide a routed connection to the Internet 109 via a telecommunications infrastructure 113. For example, cellular communications connections 116 may be implemented according to the 5G and/or 4G telecommunications protocols. The devices may also be capable of forming ad-hoc and/or ongoing device-to-device (e.g., peer-to-peer) connections 114. For example, ad-hoc connections may be implemented according to the Bluetooth protocol, and/or a near field communications (NFC) protocol.

In this example, the user devices may be connected via the Internet 109 and/or other Internet Protocol (IP)-type infrastructure to one or more hosted services 106. For example, services 106 may be hosted on one or more servers 107 located in one or more data centers. Such services may include a variety of discrete services provided by one or more software application components. Such components may communicate with each other and with the user devices according to various protocols, such as web-service technologies (e.g., HTML, asynchronous Javascript and XML (AJAX), and application programming interfaces (APIs) (e.g., JavaScript Object Notation (JSON) based RESTful interfaces). For example, servers 107 may comprise one or more content servers, transaction servers, update servers, back-end servers, management servers, database servers, crowdsourcing servers, network-related servers, or the like.

Even though a certain number of computing platforms and/or devices are illustrated herein, any number of suitable computing platforms and/or devices may be implemented to facilitate and/or support one or more techniques and/or processes associated with operating environment 100. Again, these are merely example implementations, and claimed subject matter is not limited in this regard.

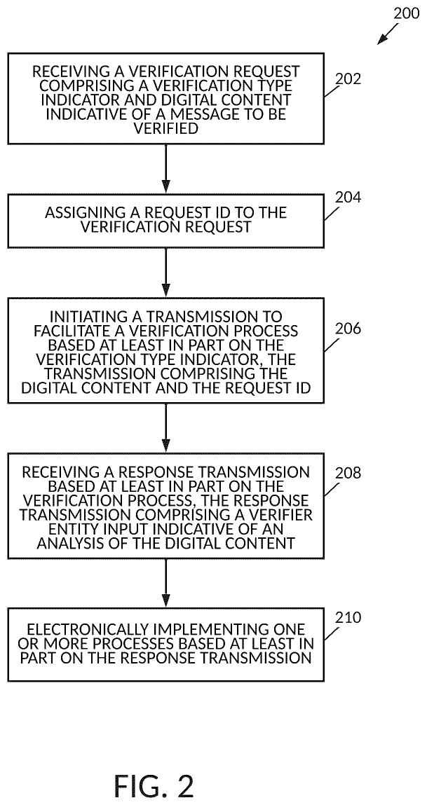

Attention is now drawn to FIG. 2, which is a flow diagram illustrating an implementation of an example process that may be performed, in whole or in part, to facilitate and/or support one or more operations and/or techniques for an e-message verification infrastructure. Even though one or more operations are illustrated and/or described concurrently and/or with respect to a certain sequence, other sequences and/or concurrent operations may be employed. In addition, although the description below references particular aspects and/or features illustrated in certain other figures, one or more operations may be performed with other aspects and/or features.

The example process may include, for example, operation 202, which may include receiving a verification request comprising a verification-type indicator and digital content indicative of an e-message to be verified. For instance, operation 202 may, for example, include a hosted service (e.g., service 106) receiving a verification request from a user device (e.g., user devices 102, 103, 104, 105), or the like.

In an example scenario, a user may, for example, receive an e-message to be verified, such as, for example, an email, a text e-message, an e-message via a cloud-based communication platform (e.g. “Slack” available from Salesforce Inc., 415 Mission Street, 3rd Floor San Francisco, CA 94105), and/or the like. For example, an e-message may purport to be from a colleague in a user's organization and/or an external sender from outside the user's organization and may request sensitive information, transfer of funds, and/or include other potentially malicious content, or the like. In some implementations, a verification request may be initiated via user device 102, 103, 104, 105, for example, via a host application executed by the user device.

In some implementations, a verification request may, for example, include digital content indicative of an e-message to be verified. For instance, digital content may, for example, include an image of the e-message. For example, digital content may, for example, include a photo of a first user device (e.g., of a display screen of a first user device 102, 103) displaying an e-message to be verified taken with a second user device (e.g., with a camera of a second user device 104, 105). As another example, digital content may include a screenshot of the e-message taken with a user device 102, 103, 104, 105 with which the e-message was received. In some implementations, digital content may include a description of the e-message. For example, digital content may include a text and/or audio description of the e-message, or the like.

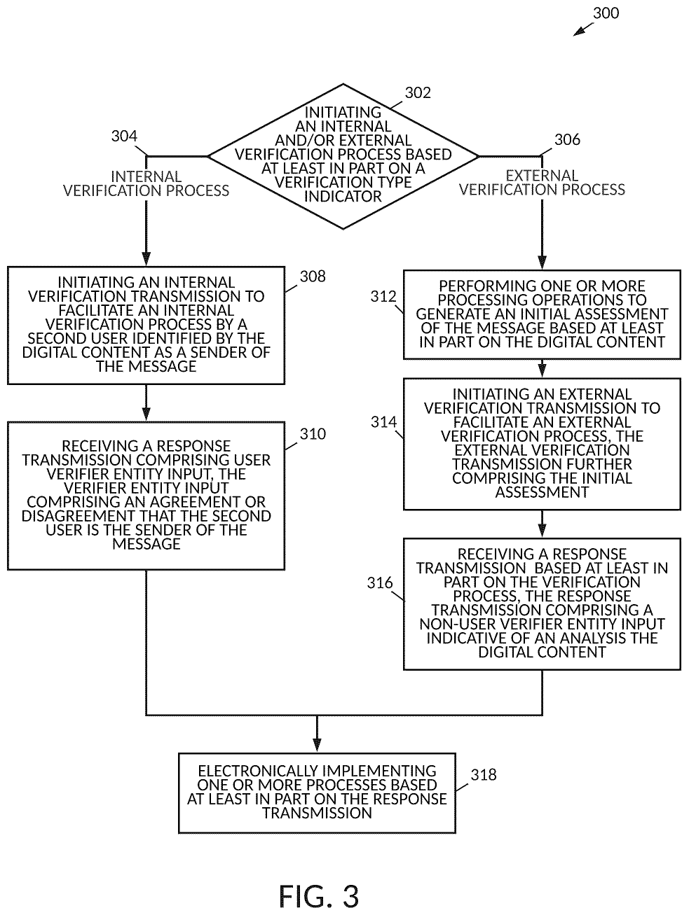

As illustrated, a verification request received in operation 202 may include a verification-type indicator. In some implementations, a verification-type indicator may determine, at least in part, a verification process that will be followed to verify an e-message. In various implementations, different verification processes may be available, such as, for example, an internal verification process and/or an external verification process (see, e.g., FIG. 3). In some implementations, a verification-type indicator may, for example, be included in the verification request responsive to a user input. For instance, via a selection of one or more options presented via a host application executed on a user device. In one or more further implementations, a verification-type indicator may be generated in other manners, such as, for example, via an analysis of digital content. For instance, a verification-type indicator may be generated based, at least in part, on text extracted from the digital content. For example, a sender's email address and/or other identification may be extracted from the digital content and a verification-type indicator may be generated based, at least in part, on a domain portion of the email address, where an internal domain may result in an internal verification-type indicator and an external domain may result in an external verification-type indicator.

The example process may further include, for example, operation 204, which may include assigning a request identifier (ID) to the verification request. For instance, a service 106 may execute operation 204 by generating a numerical, alphanumerical, and/or other like identifier. In some implementations, the request ID may comprise a unique identifier assigned to the verification request, which may facilitate the verification request to be tracked throughout a verification process. In some implementations, the request ID may indicate a verification process to be followed. For instance, the request ID may be based, at least in part, on the verification-type indicator. For example, the request ID may include a portion, such as a suffix or prefix, that indicates a verification-type and a remaining portion that uniquely identifies the verification request, or the like. Of course, any other suitable information may be included in the request ID, such as for example, a user identifier indicative of a user who initiated the verification request, a priority assigned to the request, and/or other like information. In some implementations, operation 204 may further include operations related to the request ID assignment. For instance, operation 204 may include storing the request ID, such as, for example, in a database, table and/or other data store. As another example, operation 204 may include transmitting and/or otherwise providing the request ID via a host verification application, email or other e-message, and/or the like.

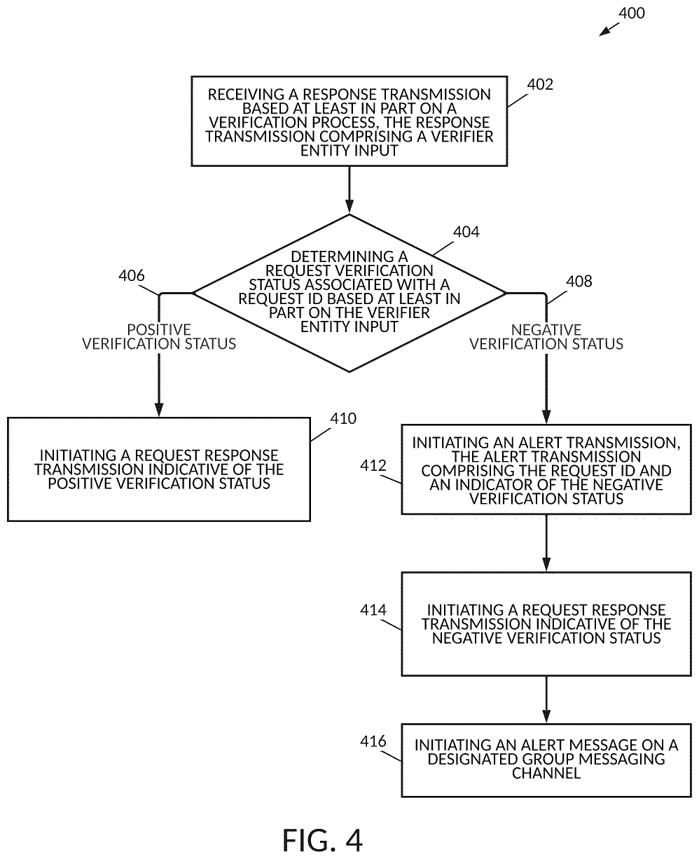

The example process may further include, for example, operation 206, which may include initiating a transmission to facilitate a verification process based, at least in part, on the verification-type indicator. In some implementations, the transmission may comprise at least digital content received in operation 202 and a request ID assigned in operation 204. For example, operation 206 may include initiating a transmission to facilitate an internal verification process based, at least in part, on an internal verification-type indicator. As a further example, operation 206 may include initiating a transmission to facilitate an external verification process based, at least in part, on an external verification-type indicator. Further aspects and/or examples of operation 206 are discussed below, such as, for example, with respect to FIGS. 4-6.

The example process may further include, for example, operation 208, which may include receiving a response transmission based, at least in part, on the verification process. In some implementations, the response transmission may comprise a verifier entity input regarding the digital content. For instance, the verifier entity input may comprise an indication of an internal verifier entity's agreement or disagreement that they were the sender of the e-message being verified. As another example, the verifier entity input may comprise an indication of an external verifier entity's assessment of the likelihood of the e-message having been genuine or malicious. Further aspects and/or examples of operation 208 are discussed below, such as, for example, with respect to FIGS. 4-6.

The example process may further include, for example, operation 210, which may include electronically implementing one or more processes based, at least in part, on the response transmission. In some implementations, operation 210 may include a determination of a positive verification status or a negative verification status. For example, a positive verification status may indicate that the e-message has been verified as genuine, while a negative verification status may indicate that the e-message may be malicious. In some implementations, different processes may be implemented based on different verification statuses. Operation 210 may include a service 106 initiating a transmission of a verification status to a user device 102, 103, 104, 105 of a verification requester. As another example, operation 210 may include implementing one or more cybersecurity operations based, at least in part, on the response transmission. For instance, operation 210 may include initiating an alert transmission for a designated entity, such as a system administrator, or the like. As another example, operation 210 may include initiating an alert message on a designated group messaging channel, such as a group messaging channel hosted by a service 106, or the like. For instance, the designated group messaging channel may be separate from and/or external to the organization's network(s). Further aspects and/or examples of operation 210 are discussed below, such as, for example, with respect to FIGS. 3 and 4.

Attention is now drawn to FIG. 3, which is a flow diagram illustrating an example process 300 of aspects of a verification process that may be performed by one or more components of an infrastructure for electronic message verification. For example, process 300 may be performed by a service 106 hosted on one or more servers 107 as described with respect to FIG. 1. In some implementations, process 300 may comprise example implementations of operations 206, 208, 210 of FIG. 2.

Process 300 may include, for example, operation 302, initiating an internal and/or external verification process based, at least in part, on a verification-type indicator. For example, operation 302 may be performed at least partly in response to receiving a verification request including a verification-type indicator. For instance, operation 302 may be performed subsequent to an operation such as operation 202 of FIG. 2. In some implementations the verification-type indicator may comprise both an internal verification and external verification indicator. For instance, an internal and external verification process may be selected, for example, in response to receiving an e-message from an external sender which carbon copies (CCs) another internal user, or vice versa. In some implementations, operation 302 may be performed based, at least in part, on the verification-type indicator comprising a portion of a request ID as described with respect to operation 204. In one or more further implementations, operation 302 may be performed based, at least in part, on the verification-type indicator(s) directly.

In some implementations, operation 302 may include initiating an internal verification process 304 based, at least in part, on an internal verification-type indicator. As an example scenario, a verification requesting user (a verification requester) may initiate a verification request in response to receiving an e-message purporting to be from another member of their organization, such as, for example, an e-message requesting a transfer of funds or other disbursement, or the like. In this example, the verification request may include an internal verification-type indicator.

Example internal verification process 304 may include, for example, operation 308, which includes initiating an internal verification transmission to a second user device executing a host verification application to facilitate an internal verification process. In some implementations, the second user device may, for example, be a device used by another user from the verification requester's organization. In one or more further implementations, the second user may be identified as a sender of the e-message by digital content of a verification request. For instance, the digital content may comprise text provided by the verification requesting host application identifying the second user, such as, for example, an email address provided by the verification requester. As another example, the digital content may comprise an image of the e-message to be verified, such as, for example, a screenshot or photograph, or the like. In this example, operation 308 may comprise performing one or more text analysis operations, such as, for example, optical character recognition, text recognition, text extraction, and/or the like on the image of the e-message to identify the second user. For instance, operation 308 may comprise performing text analysis on the image to identify a sender field within the image and to extract a sender identifier (e.g., the sender's name, email address, and/or the like) from the image. In various implementations, operation 308 may comprise other identification operations, such as, for example, performing a query on a directory using sender information within the digital content. For instance, operation 308 may include performing a query based, at least in part, on the sender information on an organization's user account directory and/or verification infrastructure user directory.

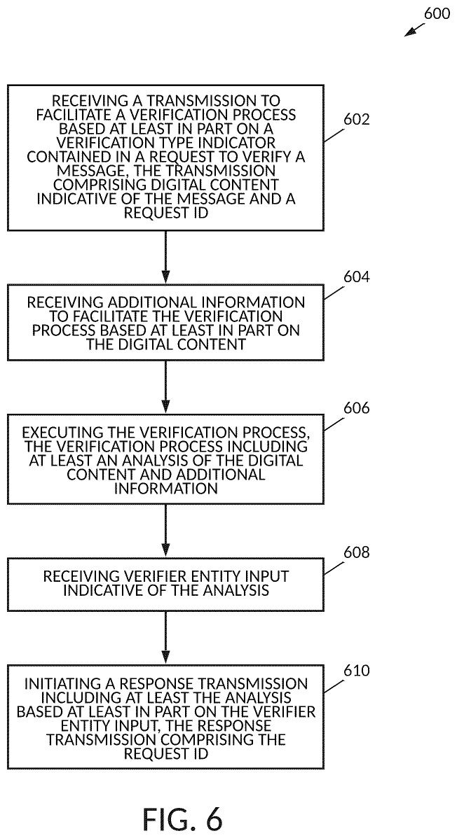

Operation 308 may further comprise initiating an internal verification transmission to a second host verification application on a second user device identified with the second user. In some implementations, operation 308 may include initiating an internal verification transmission to a user device 102, 103, 104, 105. For example, operation 308 may include initiating an internal verification transmission to be processed by a host verification application executed on the second user's device 102, 103, 104, 105. As another example, operation 308 may include initiating an internal verification transmission via one or more organizational channels, such as, for example, email, private message, and/or the like. Responsive to operation 308, a verification process may be executed, for example, as discussed with respect to FIG. 6.

Internal verification process 304 may further comprise operation 310, which may include receiving a response transmission from the host application executed by the second user device, which may include a verifier entity input. In some implementations, the verifier entity input may comprise an agreement or disagreement that the second user is the sender of the e-message. For example, operation 310 may be performed by a service 106 receiving an e-message from a user device 102, 103, 104, 105. For instance, operation 310 may comprise a host verification application executed receiving the second user's input.

Returning to operation 302, operation 302 may comprise initiating an external verification process 306 based, at least in part, on an external verification-type indicator. For instance, in an example scenario, a verification requester may request an external verification process based on receiving a potentially malicious e-message purporting to be from an external entity, such as, for example, an e-message requesting payment of an invoice, transfer of funds to an external account, and/or other potentially malicious e-messages, or the like.

External verification operation 306 may include, for example, operation 312, which includes performing one or more processing operations to generate an initial assessment of the e-message based, at least in part, on the digital content. For example, the processing operations may include filtering operations, direct or scaling point assignment operations, statistical classification operations, natural language processing operations, supervised learning operations such as a random forest or other decision tree based scoring operations, unsupervised learning operations such as attention-based recurrent neural network operations, ensembles and/or other combinations thereof, and/or the like. For example, operation 312 may include evaluating text extracted from the digital content using an artificial neural network trained on a corpus of example e-messages, or the like (e.g., publicly accessible phishing email corpuses, e-messages previously received the organization, combinations thereof, and/or the like). In some implementations, the initial assessment may comprise a measure of a likelihood that the e-message may be potentially malicious. For example, the initial assessment may comprise a descriptor and/or value indicative of a confidence level result of the initial assessment, or the like. As an example, the initial assessment may comprise a value from a confidence level scale, such as, for instance a three-level scale (e.g., 1/“Unlikely malicious”, 2/“Indeterminate”, 3/“Likely malicious”), a five-level scale (e.g., “1/“Highly unlikely malicious”, 2/“Unlikely malicious”, 3/“Indeterminate”, 4/“Likely malicious”, 5/“Highly likely malicious”), and/or the like. In one or more further implementations, the initial assessment may comprise additional assessment information such as, for example, extracted and/or highlighted text or other portions of the digital content that influenced a confidence level result.

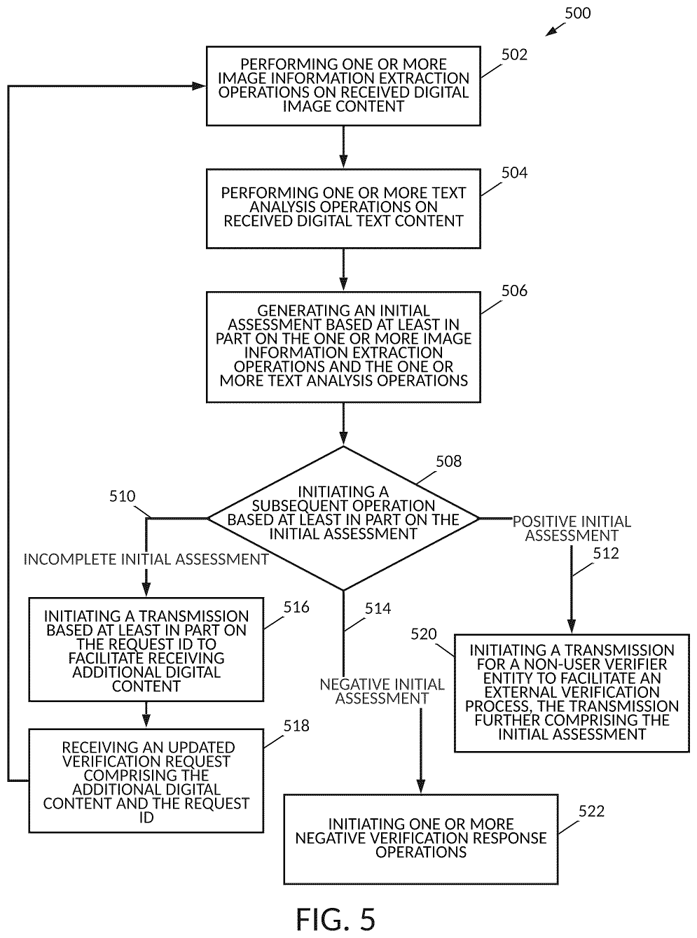

In some implementations, operation 312 may comprise retrieving additional information based, at least in part, on the digital content. For example, operation 312 may comprise extracting text from an image of the e-message to identify the e-message on a server, such as an email server. In this example, operation 312 may comprise retrieving a copy of the e-message. For instance, a verification server or other component of an e-message verification infrastructure may have access to an organization's messaging system (e.g., email server, chat messages, and/or the like). In some implementations, operation 312 may comprise performing one or more processing operations on the copy of the e-message. For instance, operation 312 may comprise analyzing header fields to generate the initial assessment, such as, for example, Return-Path, Received, Message-ID, Sender Policy Framework (SPF), Domain Keys Identified Mail (DKIM) Signature, and/or the like. As an example, operation 312 may comprise comparing information contained in one or more header fields to a deny list of known malicious sources and/or an allow list of known/approved safe senders. For instance, an initial assessment of the e-message may include descriptors describing the sender's presence in one or more such lists. Further examples of operation 312 are described with respect to FIG. 5.

In some implementations, external verification process 306 may comprise operation 314, which may include initiating an external verification transmission to facilitate an external verification process. In some examples, the external verification transmission may comprise the initial assessment generated in operation 312. In some implementations, a non-user verifier entity may be a person external to the requesting user's organization. For instance, operation 312 may comprise a service 106 transmitting the external verification transmission to a device 102, 103, 104, 105 operated by the non-user verifier entity via a host verification application executed on the device 102, 103, 104, 105. In one or more further implementations, a non-user verifier entity may, for example, comprise a service (e.g., a second service 106) and/or process (e.g., a process executed by the same service 106 that performs process 300), and/or the like. Various examples of operations that may be performed with respect to a non-user verifier entity are described with respect to FIG. 6.

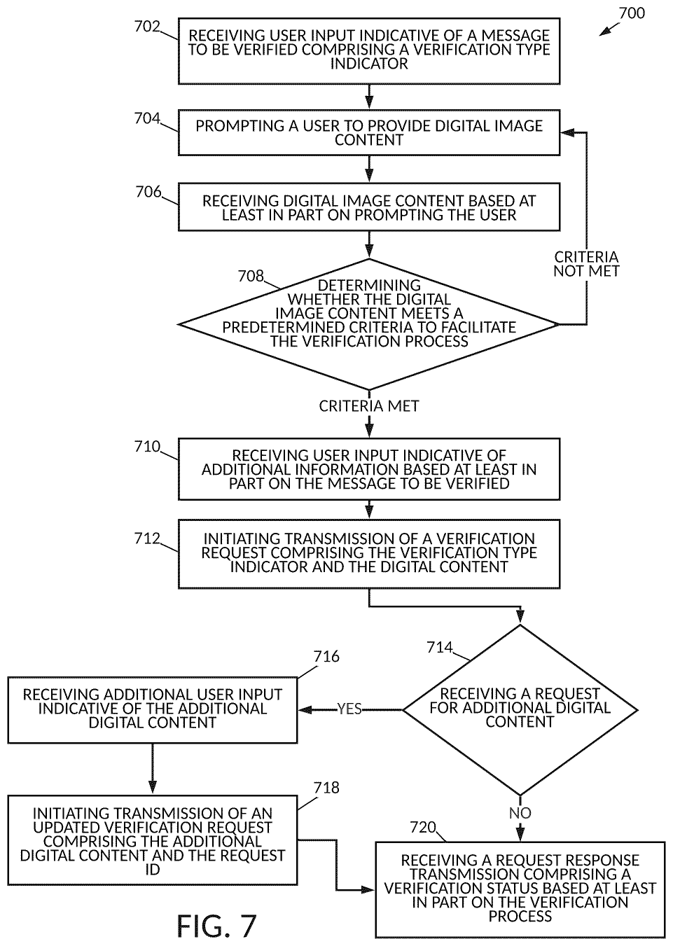

In some implementations, external verification process 306 may comprise operation 316, which may, for example, include receiving a response transmission including a non-user verifier entity input based, at least in part, on the verification process. For example, the response transmission may comprise a verifier entity input regarding the digital content. In some implementations, the verifier entity input may, for example, comprise an indication of a verification status. For example, the verifier entity input may comprise an indicator of positive verification status (e.g. that the e-message may be genuine/verified) or an indicator of negative verification status (e.g., that the e-message may be malicious/disputed), or the like. In one or more further implementations, the verifier entity input may, for example, comprise text and/or other descriptive input. For example, the verifier entity input may comprise a narrative requesting additional information, which may transmitted to the requesting user's host verification application (see, e.g., FIG. 7). FIG. 6 provides further examples of verifier entity input that may be received in operation 316.

Example process 300 may further comprise operation 318, which may include electronically implementing one or more processes based, at least in part, on the response transmission received in operation 310 and/or operation 316. For example, operation 318 may comprise an implementation of operation 210 of FIG. 2 and/or process 400 of FIG. 4.

Attention is now drawn to FIG. 4, which is a flow diagram illustrating an example process 400 of electronically implementing one or more processes based, at least in part, on a verification process. For example, process 400 may comprise an example implementation of operation 210 of FIG. 2. Accordingly, process 400 may, for example, be executed in the context of a verification request assigned a request ID as discussed with respect to operations 202 and 204 of FIG. 2 and/or process 300 of FIG. 3. In some implementations, aspects of the illustrated process 400 may, for example, be performed by one or more components of an infrastructure for electronic message verification. For example, process 400 may be performed by a service 106 hosted on one or more servers 107 as described with respect to FIG. 1.

Process 400 may include, for example, operation 402, which includes receiving a response transmission based, at least in part, on a verification process. For example, operation 402 may be performed in response to a previous transmission to a facilitate a verification process as discussed with respect to operation 206 of FIG. 2 and/or operations 308, 314 of FIG. 3. In some implementations, the response transmission may, for example, comprise a verifier entity input, such as, for example, an a verifier entity assessment of an e-message to-be-verified. For example, operation 402 may be performed as an implementation of operation 208 of FIG. 2, operation 310 and/or operation 314 of FIG. 3. For instance, operation 402 may comprise receiving a response from an internal verifier user entity device, for example, via a host verification application and/or receiving a response from an external verifier verification application.

Process 400 may further include, for example, operation 404, which includes determining a request verification status associated with a request ID based, at least in part, on the verifier entity input received in operation 402. In some implementations, operation 404 may comprise determining a positive verification status based, at least in part, on a positive verifier entity input. For example, the positive verifier entity input may comprise input received from an internal verifier entity (e.g., a user identified by request-related digital content as a sender of an inter-organizational e-message). Further, the positive verifier entity input received from the internal verifier entity may, for example, comprise an agreement that the internal verifier entity is the sender of the e-message, or the like. As another example, the positive verifier entity input may may comprise input received from an external verifier entity (e.g., a non-user verifier entity external to the organization). In this example, the positive verifier entity input received from the external verifier entity may, for example, comprise an input regarding digital content associated with the request (e.g., an image of the e-message and/or text describing the e-message, or the like). Further, the input may be indicative of a positive determination that the e-message is verified (e.g., that the e-message is non-malicious).

Responsive to a positive verification status 406, process 400 may comprise electronically implementing one or more positive-verification related processing operations 410. In some implementations, executing the one or more positive-verification related processing operations may, for example, be implemented as described with respect to operation 210 of FIG. 2 and/or operation 318 of FIG. 3. In some implementations, operation 410 may comprise, for example, initiating a request response transmission to the verification requester. In some examples, the request response transmission may be indicative of the positive verification status. For instance, the request response transmission may, for example, comprise an approval for the verification requester to treat the e-message as genuine/verified (e.g., to respond to the e-message, take action requested by the e-message, and/or the like). In some implementations, operation 410 may comprise initiating a request response transmission via updating a status of the request associated with the request ID. For example, request data for the e-message verification infrastructure may be stored in a data store, such as, for example, a database. In some examples, operation 410 may comprise updating a status stored in the data store in association with the request ID. In further examples, the verification requester may receive the request response via an updated status provided by a host e-message verification application executed on a user device (e.g., a user device 102, 103, 104, 105 of FIG. 1). For example, operation 410 may comprise triggering a notification message to be displayed via a user device and/or updating a displayed status on a host verification application dashboard, panel, and/or other like status display provided by a host verification application. In further examples, operation 410 may comprise transmitting an e-message via other channels, such as for example, an email or message sent via a messaging channel, or the like.

Returning to operation 404, in some implementations, operation 404 may comprise determining a negative verification status 408 based, at least in part, on a negative verifier entity input. For example, the negative verifier entity input may comprise an internal verifier entity input (e.g., a user input from a user identified by request-related digital content as a sender of an inter-organizational e-message). Further, the negative verifier entity input received from the internal verifier entity may, for example, comprise a disagreement that the internal verifier entity is the sender of the e-message. As another example, the negative verifier entity input may comprise an external verifier entity input (e.g., input from a non-user verifier entity external to the organization). In some examples, the negative verifier entity input may comprise an input regarding digital content associated with the request (e.g., an image of the e-message and/or text describing the e-message, or the like). Further, the input may, for example, be indicative of a negative determination that the e-message is not verified (e.g., that the e-message is malicious). Responsive to a negative verification status 408, process 400 may, for example, include electronically implementing one or more processes such as negative verification related operations 412, 414, 416.

Process 400 may include, for example, operation 412, which may include initiating an alert transmission to a designated entity. In some implementations, the alert transmission may comprise the request ID and an indicator of the negative verification status. In some implementations, the designated entity may be established via a security policy and/or other like system configuration. For example, the designated entity may comprise a designated member of the requester organization (e.g., a designated cybersecurity officer, an internal system administrator, and/or the like). As another example, the designated entity may comprise an entity external to the requester organization (e.g., an external system administrator, external system operator, and/or the like). In some implementations, operation 412 may comprise initiating an alert transmission via a host verification application. For instance, operation 412 may comprise updating an administrator panel, dashboard, and/or the like to display an alert including the request ID. As another example, operation 412 may comprise initiating an alert transmission on another channel, such as, for example, an email, messaging channel, and/or the like.

Responsive to negative verification status 408, process 400 may further include, for example, operation 414, which includes initiating a request response transmission to the verification requester that may be indicative of the negative verification status. For instance, the request response transmission may comprise a disapproval, denial, and/or other indicator that the verification requester to treat the e-message as malicious (e.g., to not respond to the e-message, take no action requested by the e-message, delete the e-message, and/or the like). In some implementations, operation 414 may, for example, comprise initiating a request response transmission via updating a status of the request associated with the request ID. For example, request data for the e-message verification infrastructure may be stored in a data store, such as, for example, a database, or the like. In some examples, operation 414 may comprise updating a status stored in the data store in association with the request ID. In further examples, the verification requester may receive the request response via an updated status provided by a host e-message verification application executed on a user device (e.g., a user device 102, 103, 104, 105 of FIG. 1). For example, operation 414 may comprise triggering a notification e-message to be displayed via a user device and/or updating a displayed status on a host verification application dashboard, panel, and/or other like status display provided by a host verification application. In further example, operation 414 may comprise transmitting an e-message via other channels, such as for example, an email or message sent via a messaging channel.

Responsive to negative verification status 408, process 400 may further include, for example, operation 416, which includes initiating an alert message on a designated group messaging channel. In some implementations, an e-message verification infrastructure may, for example, comprise a group messaging platform hosted externally to an organization, such as, for example a Slack server and/or other like messaging platforms. The designated group messaging channel may, for example, be a channel of a group messaging workspace allocated to the organization, or the like. For instance, the group messaging channel may be created via workspace initialization or other configuration, such as when an organization joins an e-message verification infrastructure. As another example, the group messaging channel may be allocated responsive to the e-message receiving a negative verification. For instance, a dedicated group messaging conversation may be created for the alert message. In various implementations, the alert message may, for example, include various information related to the e-message, such as, for example, a sender identifier (e.g., sender email address), a copy of digital content included in the verification request, date/time that the e-message was received, and/or the like.

In one or more further implementations, operation 416 may, for example, be performed based, at least in part, on a verification-type. For instance, a negative internal verification may be indicative of a compromised organizational cybersecurity system, such as compromised user credentials, while a negative external verification may be indicative of an attempted cybersecurity intrusion. For example, operation 416 may comprise initiating an alert message on a group messaging channel corresponding to a verification-type. For instance, a first group messaging channel may correspond to internal verifications and a second group messaging channel may correspond to external verifications. As another example, operation 416 may comprise initiating a first alert message-type corresponding to a negative internal verification and initiating a second alert message type corresponding to a negative external verification. For instance, the first alert message may comprise a heightened alert message compared to the second alert message.

In one or more further implementations, a group messaging channel may convey other e-message types, such as security alerts/notifications issued by a system administrator or other authorized user. For instance, the group messaging channel may convey e-messages describing actions taken in response to a negative verification. As another example, the group messaging channel may include a notification to raise awareness within the organization of potential cybersecurity threats. In one or more further implementations, the group messaging channel may, for example, further provide a channel for organization members (e.g., e-message verification infrastructure users) to communicate. For example, the group messaging channel may provide a channel for group-level conversations, private conversations, public conversations, and/or the like. For instance, the group messaging channel may provide a communication channel separate from the organization's internal channels to facilitate organizational communication in the event that the organization's internal channels are compromised.

In one or more further implementations, process 400 may comprise electronically implemented further processes based, at least in part, of the response transmission. For example, process 400 may comprise logging completed and/or ongoing verification requests (e.g., in a database keyed by request IDs and/or the like). As another example, process 400 may comprise accessing an organizations internal communication channels to address a negative verification. For instance, process 400 may comprise deleting a negatively verified e-message from a user's email account and/or quarantining such an e-message.

Attention is now drawn to FIG. 5, which is a flow diagram illustrating an example process 500 of performing one or more processing operations to generate an initial assessment of an e-message, as well as some example operations which may be performed in response to the initial assessment. For example, process 500 may be an implementation of operations 312 and 314 of FIG. 3. Accordingly, in some implementations, process 500 may be performed responsive to receiving a verification request e-message comprising an external verification-type indicator. In one or more further implementations, process 500 may be performed responsive to receiving a verification request e-message regardless of verification-type indicator. As an example, process 500 may be performed by a service (e.g., service 106 of FIG. 1) responsive to receiving a verification request from a user device (e.g., user device 102, 103, 104, 105).

Example process 500 may include, for example, operation 502, which includes performing one or more image information extraction operations on received digital content. For example, the received digital content may be from a received verification request e-message (e.g., a verification request e-message received in operation 202 of FIG. 2 and/or an updated verification request e-message as discussed below with respect to operation 518). In some implementations, the received digital content may comprise an image of an e-message (e.g., a screenshot, photograph of the e-message displayed on a user device, and/or the like). The one or more image information extraction operations may, for example, comprise any suitable image processing operations. For example, operation 502 may comprise performing preprocessing operations on the received digital content, such as, for example, de speckling, line remove, layout/zone analysis, aspect/scale normalization, and/or the like. As another example, operation 502 may comprise performing text recognition operations on the received digital content (including, for example, preprocessed digital content) such as, for example, optical character and/or word recognition operations such as, for example, matrix matching, pattern recognition, image correlation, feature extraction, nearest neighbor classification, and/or the like.

Example process 500 may further include, for example, operation 504, which may comprise performing one or more text analysis operations on received digital text content. For example, the received digital text content may be text extracted from an image in operation 502. As another example, the received digital text content may be text received via a user input, such as a verification requester's narrative with respect to the e-message, or the like. The one or more text analysis operations may, for example, comprise any suitable text analysis operations, such as, for example, tokenizing, name recognition, chunking, lemmatizing, stemming, part-of-speech classification, and/or the like.

Example process 500 may further include, for example, operation 506, which may comprise generating an initial assessment based, at least in part, on the one or more image information extraction operations 502 and the one or more text analysis operations 506. In some implementations, operation 506 may, for example, comprise one or more processing operations such as those described with respect to operation 312 of FIG. 3. For example, operation 506 may include filtering operations, direct or scaling point assignment operations, statistical classification operations, natural language processing operations, supervised learning operations such as a random forest or other decision tree based scoring operations, unsupervised learning operations such as attention-based recurrent neural network operations, ensembles and/or other combinations thereof, and/or the like. For example, operation 506 may include evaluating text extracted from the digital content in operation 502 and/or text analyzed in operation 504 using an artificial neural network, such as, for example, a deep neural network, feed-forward neural network, convolutional neural network, and/or the like. For instance, the artificial neural network may be trained on a corpus of example e-messages (e.g., publicly accessible phishing email corpuses, e-messages previously received the organization, combinations thereof, and/or the like) to output an indicator of the e-message's legitimacy. In this example, the artificial neural network may output a binary result (e.g., “legitimate” or “malicious”), a multi-leveled result (e.g., a legitimacy confidence score), or the like.

In some implementations, the initial assessment may, for example, comprise a measure of a likelihood that the e-message is potentially malicious. For example, the initial assessment may comprise a descriptor and/or value indicative of a confidence level result of the initial assessment. As an example, the initial assessment may comprise a value from a confidence level scale, such as, for instance a three-level scale (e.g., 1/“Likely legitimate”, 2/“Indeterminate”, 3/“Likely malicious”), a five-level scale (e.g., “1/“Highly likely legitimate”, 2/“Likely legitimate”, 3/“Indeterminate”, 4/“Likely malicious”, 5/“Highly likely malicious”), and/or the like. In one or more further implementations, the initial assessment may, for example, comprise additional assessment information such as, for example, extracted and/or highlighted text or other portions of digital content that influenced a confidence level result, or the like. For instance, an initial assessment generated via a feature-based classification technique may, for example, include a list of which features influenced the output by more than a threshold amount.

Example process 500 may further include, for example, operation 508, which may comprise initiating a subsequence operation based, at least in part, on the initial assessment. In the illustrated implementation, operation 508 may include initiating operations based, at least in part, on an incomplete initial assessment 510, a negative initial assessment 514, and/or a positive initial assessment 512. In one or more further implementations, subsequent operations may, for example, be based on other conditions, such as, for example, an initial assessment confidence level. For instance, operation 522 might be performed based, at least in part, on meeting a threshold confidence level of a malicious e-message (e.g., a 9 or 10 on a ten point scale ranging from a relatively high confidence of legitimacy to a relatively high confidence of maliciousness), or the like. In some implementations, various aspects of operation 508 and subsequent operations may, for example, be configurable parameters. For instance, an organization's security policy may include configuration parameters to govern whether or not operation 522 may be performed automatically based, at least in part, on a negative initial assessment 514, and so on.

Example process 500 may include, for example, operations 516 and 518 which may be performed based, at least in part, on an incomplete initial assessment 510. For example, an incomplete initial assessment 510 may be based on a failure of an analysis operation such as operations 502, 504. For instance, an incomplete initial assessment 510 may be based, at least in part, on an image quality being insufficient to perform information extraction operations 502. As another example, an incomplete initial assessment 510 may be based, at least in part on a failure to parse or otherwise analyze the received digital text content in operation 504.

Operation 516 may comprise, for example, initiating a transmission to a requesting host verification application based, at least in part, on the request ID to facilitate receiving additional content. For example, the request ID may be used, in whole or in part, to identify the user who requested the e-message verification to initiate a transmission to the user's host verification application. For instance, a notification message may be transmitted via a host e-message verification application, email, messaging channel, and/or the like. As another example, the request ID may be used, in whole or in part, to identify the request to initiate a request status update (e.g., to “incomplete,” “additional information needed”, etc.), which may be transmitted via a request status displayed by a host verification application executed on the user's device. In some implementations, the transmission may, for example, facilitate receiving additional digital content by requesting new and/or updated digital content (e.g., a request to retake a picture of an e-message, to clarify the e-message sender's purported identity, to provide a missing text narrative, to correct an apparently erroneous verification-type identifier, and/or the like).

Operation 518 may comprise, for example, receiving an updated verification request comprising the additional content and the request ID. For instance, operation 518 may comprise retrieving updated digital content from a data store based on a status update indicating that the verification request has been updated via the requesting user host verification application. As another example, operation 518 may comprise receiving a transmission including a copy of the updated request including updated digital content. In some implementations, process 500 may include performing operations 502-508 on the received updated digital content.

Example process 500 may further comprise, for example, operation 520, which may be performed based, at least in part, on a positive initial assessment 510. For example, operation 520 may be performed based, at least in part, on an initial assessment indicative of a legitimate e-message as discussed above with respect to operation 506. Operation 520 may, for example, comprise initiating a transmission to facilitate an external verification process by a non-user verifier entity. In one or more further implementations, operation 520 may comprise including the initial assessment in the transmission to the non-user verifier entity. In some implementations, operation 520 may be as described with respect to operation 206 of FIG. 2 and/or operation 314 of FIG. 3.

Example process 500 may further comprise, for example, operation 522, which may be performed based, at least in part, on a negative initial assessment. For example, operation 522 may be performed based, at least in part, on an initial assessment indicative of a malicious e-message as discussed above with respect to operation 506. In some implementations, operation 522 may comprise, for example, initiating one or more negative verification response operations. For example, operation 522 may comprise initiating one or more negative verification status 408 operations 412, 414, 416, as discussed with respect to FIG. 4. In one or more further implementations, operation 522 may comprise further operations, such, for example, as initiating an external verification request transmission as discussed with respect to operation 314 of FIG. 3. For example, operation 522 may comprise initiating a request response transmission to the verification requester as discussed with respect to operation 414 of FIG. 4 and initiating an external request transmission as discussed with respect to operation 314 of FIG. 3. For instance, the verification requester may be informed that the e-message appears malicious based, at least in part, on the initial assessment and that the e-message will be subject to further verification.

Attention is now drawn to FIG. 6, which is a flow diagram illustrating an example verification process 600. For example, example process 600 may be a verification process performed responsive to operation 206 of FIG. 2, operations 314 or 308 of FIG. 3, and/or operation 520 of FIG. 5. In some implementations, example process 600 may be performed by a user device (e.g., user device 102, 103, 104, 105 of FIG. 1). For example, example process 600 may be performed by a verification system user's device for an internal verification process or a human non-user verifier entity's device for an external verification process. In one or more further implementations, example process 600 may be performed by a non-user verifier entity service hosted on a server (e.g., a service 106 hosted on server 107), such as, for example, for an external verification process.

Example process 600 may include, for example, operation 602, which may include receiving a transmission to facilitate an e-message verification process. For example, operation 602 may comprise receiving a verification transmission initiated by an e-message verification service as discussed above. In some implementations, the transmission may be based, at least in part, on a verification-type indicator that was contained in a request to verify an e-message. Further, the transmission may, for example, comprise digital content indicative of the e-message and a request ID for the request. For example, the digital content may image and/or text content, or the like, as discussed above, for example, with respect to operation 202 of FIG. 2 and/or operations 502 of FIG. 5.

Example process 600 may include, for example, operation 604, which may include receiving additional information to facilitate the verification process based, at least in part, on the digital content. In some implementations, operation 604 may, for example, comprise receiving additional information within the transmission received in operation 602, such as, for example, an initial assessment of the e-message generated as discussed with respect to operation 506 of FIG. 5. In some implementations, operation 604 may include receiving additional information as an aspect of an investigation conducted by the verifier entity. For example, a verifier entity may retrieve information available via the Internet, a database of organizations/entities, and/or the like based, at least in part, on the digital content. For instance, operation 604 may comprise receiving information related to the purported sender of the e-message, the purported sender's organization, and/or the like. In some implementations, operation 604 may comprise receiving information from the requester's organization. For example, operation 604 may include receiving a copy of the e-message, which may include headers and/or other metadata related to the e-message. As another example, operation 604 may include receiving information related to any past interactions with the purported sender, such as copies of previous e-messages received. In some implementations, operation 604 may, for example, comprise receiving additional information from the verification requester via a host e-message verification application.

Example process 600 may include, for example, operation 606, which may include executing the verification process including at least an analysis of the digital content and additional information. For example, operation 606 may include displaying and/or otherwise presenting the additional information and the digital content for the verifier entity to conduct an analysis of whether the digital content conforms to the information received in operation 604. For instance, operation 606 may comprise displaying the e-message sender's email address and/or signature retrieved from the digital content as well as information regarding the sender received in operation 604 to determine if the e-message's sender information matches sender information retrieved during an investigation in operation 604.

As another example, operation 606 may comprise performing one or more processing operations, which may include for example, filtering operations, direct or scaling point assignment operations, statistical classification operations, natural language processing operations, supervised learning operations such as a random forest or other decision tree based scoring operations, unsupervised learning operations such as attention-based recurrent neural network operations, ensembles and/or other combinations thereof, and/or the like. For instance, operation 606 may be performed as described with respect to operation 506, with the additional input of the additional information received in operation 604.

Example process 600 may further include, for example, operation 608, which includes receiving verifier entity input indicative of the analysis. For example, with respect to an internal verification process, operation 608 may comprise receiving a verifier entity input indicative of an agreement or a disagreement that the verifier entity is the sender of the e-message. As an example, with respect to an external verification process, operation 608 may comprise receiving a non-user verifier entity's analysis of the legitimacy of the e-message. For instance, operation 608 may comprise receiving verifier entity input via a user interface of a host e-message verification application, such as, for example, a form, checkbox, list, virtual button, and/or other like user interface elements.

Example process 600 may further include, for example, operation 610, which may include initiating a response transmission including at least the analysis based, at least in part, on the verifier entity input. In some implementations, the response transmission may, for example, comprise the request ID. For instance, operation 610 may be performed to initiate a response transmission that may be received as discussed with respect to operation 208 of FIG. 2, operation 310 and/or 316 of FIG. 3, and/or operation 402 of FIG. 4. For instance, operation 610 may comprise initiating a status update of the request based, at least in part, on the request ID, such as, for example, updating the status to a positive verification status (e.g., “legitimate message”, “verified”, “approved”, etc. . . . ) or a negative verification status (e.g., “phishing attack”, “illegitimate message”, “malicious”, etc. . . . ).

Attention is now drawn to FIG. 7, which is a flow diagram illustrating an example process 700 of user interaction with a host e-message verification application. For example, process 700 may be performed by a user device (e.g., user device 102, 103, 104, 105) executing a host e-message verification application operated by a verification requester in communication with a verification service (e.g., service 106 hosted on server 107).

Example process 700 may include, for example, operation 702, which may include a host application receiving user input indicative of an e-message to be verified. In some implementations, the user input may, for example, include a verification-type indicator. For example, operation 702 may comprise receiving user input to initiate a new e-message verification request. For instance, operation 702 may comprise receiving a user selection and/or other input to a host e-message verification application user interface, such as, for example, via a graphical control element (e.g., a button). Operation 702 may, for example, further comprise receiving a user input indicative of a verification-type. For example, operation 702 may comprise receiving a user selection of an external and/or internal verification-type via an application graphical control element. As an example, operation 702 may be performed in response to a user receiving an e-message (e.g., an email) that appears potentially malicious such as, for example, a request for a transfer of funds or other financial transaction. For instance, if the e-message is received from a sender that appears to be within the user's organization, an internal verification may be requested to have the internal sender verify that they did send the e-message. As another example, if the e-message is received from a sender that appears to be external to the user's organization, an external verification may be requested to have a non-user verifier entity analyze the e-message.

Example process 700 may include, for example, operation 704, which may include prompting a user to provide digital image content. In some implementations, operation 704 may, for example, further include providing an interface to a camera for taking pictures, such as via an operating system API on a user device. For instance, operation 704 may comprise a first user device (executing a host e-message verification application) prompting the user to take a picture of the e-message displayed on a second user device (e.g., executing an email application). In one or more further implementations, operation 704 may, for example, comprise prompting the user to upload an existing image, such as a screenshot or previously captured image. For instance, operation 704 may comprise providing an image selection graphical control, such as, for example, via an operating system API.

Example process 700 may further include, for example, operation 706, which includes receiving digital image content. For example, operation 706 may comprise capturing an image using a camera component of a user device, or receiving an uploaded/selected preexisting image, as discussed above.

Example process 700 may further include, for example, operation 708, which may include determining whether the digital image content meets a predetermined criteria to facilitate the verification process. For example, the predetermined criteria may include image quality criteria, such as, for example meeting a threshold level of image brightness, sharpness, contrast, and/or the like and/or having less than a threshold level of blur, noise, distortion, and/or the like. As another example, operation 708 may comprise preprocessing operations such as feature extraction, shape recognition, and/or the like. For instance, operation 708 may comprise determining if text is present in the image, if the image has captured a displayed e-message, and/or the like. Process 700 may, for example, comprise returning to operation 704 if the criteria is not met. For example, operation 704 may comprise prompting the user to retake the picture and/or upload a different image.

Example process 700 may further include, for example, operation 710, which may include receiving user input indicative of additional information based, at least in part, on the e-message to be verified. As illustrated, operation 710 may be performed in response to meeting the criteria discussed in operation 708. Of course, in other examples, the illustrated operations may be performed in any consistent order. For instance, operation 710 may be performed prior to and/or in parallel with operation 704. In some implementations, operation 710 may comprise providing a text entry control element to receive textual user input. For instance, the text input may comprise a user narrative describing the e-message, circumstances surrounding the e-message, and/or the like. As another example, operation 710 may comprise prompting the user to provide certain information, such as for example, the sender's email address. For instance, in some cases, an email may display a sender's email display name rather than their email address, and operation 710 may, for example, be performed to receive the sender's email address. As another example, operation 710 may comprise receiving additional image content. For instance, operation 710 may comprise prompting a user to provide an image of email's headers (e.g., via instructing the user to display the headers in their email application).

Example process 700 may further include, for example, operation 712, which may include initiating transmission of a verification request comprising the verification-type indicator provided in operation 702 and the digital content provided in operations 704 and/or 710. For example, operation 712 may comprise a user device transmitting a verification request to be received by a server-hosted e-message verification service as discussed with respect to operation 202 of FIG. 2.

Example process 700 may further include, for example, operation 714, which may include receiving a request for additional digital content. For example, a host e-message verification application may comprise a dashboard, panel, and/or other graphical element to display status of an in-process e-message verification request. In some implementations, operation 714 may comprise receiving a status update indicative of a request for additional content. In one or more further implementations, operation 714 may, for example, comprise receiving a notification and/or other like alert message indicative of the requested additional content. In some implementations, operation 714 may be performed in response to an information request as described with respect to operation 516 of FIG. 5. In one or more further implementations, operation 714 may be performed with respect to other aspects of a verification process. For instance, operation 714 may be performed in response to internal verifier entity input requesting additional information (e.g., via a chat functionality provided by the host e-message verification application). As another example, operation 714 may be performed in response to an external verifier entity request, such as, for example, as described with respect to operation 604 of FIG. 6.

Example process 700 may further include, for example, operation 716, which may include receiving additional user input indicative of the additional digital content. For instance, operation 716 may comprise receiving additional image content (e.g., in response to a request to provide a higher-quality image of the e-message), receiving additional text content (e.g., in response to request for clarification or as part of a conversation initiated by an internal user verifier entity, etc. . . . ). For instance, operation 716 may be performed as discussed with respect to operations 706 and/or 710.

Example process 700 may further include, for example, operation 718, which may include initiating transmission of an updated verification request comprising the additional digital content and the request ID. For example, operation 718 may comprise a user device executing a host e-message verification application initiating a transmission to an e-message verification service as described with respect to operation 518 of FIG. 5. As another example, operation 718 may comprise a user device executing a host e-message verification application initiating a transmission to another user device operated by an internal user verifier entity, such as, for example via an electronic messaging interface as indicated above.

Example process 700 may further include, for example, operation 720, which may include receiving a request response transmission comprising a verification status based, at least in part, on the verification process. For example, operation 720 may be performed responsive to a verification process completed after an updated request operation 718, or may be performed responsive to an initial request operation 712 if a request for additional content is not received. In some implementations, operation 720 may, for example, comprise receiving a verification response transmission from an e-message verification service as described with respect to operations 410 and/or 414 of FIG. 4. For example, operation 720 may comprise receiving a verification response transmission indicating a positive verification status (e.g., that the e-message is legitimate) or a negative verification status (e.g., that the e-message is malicious). In one or more further implementations, operation 720 may comprise receiving further responses, such as, for example, a notification of an alert message posted on a designated group messaging channel as described with respect to operation 416.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components and/or memory states, as examples, necessarily implies that memory, such memory components and/or memory states, continuing with the example, is tangible.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit and/or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If, alternatively, reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements and/or identical results, unless otherwise expressly indicated.

It is further noted that the terms “type” and/or “like,” if used, such as with a feature, structure, characteristic, and/or the like, using “optical” and/or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices, one or more server devices and/or one or more peer-to-peer devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device, a client device and/or a peer-to-peer device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present disclosure, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present disclosure, use of the term “Hadoop” is intended to include versions, presently known and/or to be later developed.

In the context of the present disclosure, the term “network device” refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in a non-transitory memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” and/or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present disclosure, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is facilitated and/or, in at least some instances, may be transparent. In the context of the present disclosure, the term “transparent,” if used with respect to particular communicating devices of a network, refers to the devices communicating via the network in which the devices are able to communicate via one or more intermediate devices, such as of one or more intermediate nodes, but without the communicating devices necessarily specifying the one or more intermediate nodes and/or the one or more intermediate devices of the one or more intermediate nodes. Thus, a network may include the one or more intermediate nodes and/or the one or more intermediate devices of the one or more intermediate nodes in communications and the network may engage in communications via the one or more intermediate nodes and/or the one or more intermediate devices of the one or more intermediate nodes, but the network may operate as if such intermediate nodes and/or intermediate devices are not necessarily involved in communications between the particular communicating devices. For example, a router may provide a link and/or connection between otherwise separate and/or independent LANs.

In the context of the present disclosure, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source and/or designated destination for one or more signal packets and/or signal frames, for example. It is understood in the context of the present disclosure that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present disclosure, may comprise a service that organizes stored digital content, such as, for example, text, images, video, etc., through the use of hypermedia, for example. It is noted that a network, such as the Internet and/or Web, may be employed to store electronic files and/or electronic documents.

The term “electronic file” and/or the term “electronic document” or the like are used throughout this document to refer to a set of stored memory states and/or a set of physical signals associated in a manner to at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present disclosure, the term “Web site” and/or similar terms refer to Web pages that are associated electronically to form a particular collection thereof. Also, in the context of the present disclosure, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

As was indicated, in the context of the present disclosure, the terms “entry,” “electronic entry,” “document,” “electronic document,” “content,”, “digital content,” “item,” “object,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present disclosure, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed and/or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present disclosure, a component is physical, but is not necessarily tangible. As an example, components with reference to an electronic document and/or electronic file, in one or more embodiments, may comprise text, for example, in the form of physical signals and/or physical states (e.g., capable of being physically displayed and/or maintained as a memory state in a tangible memory). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed and/or maintained as a memory state in a tangible memory). In an embodiment, digital content may comprise, for example, text, images, audio, video, haptic content and/or other types of electronic documents and/or electronic files, including portions thereof, for example.

Also, in the context of the present disclosure, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” and/or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this disclosure, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present disclosure, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer and/or in a “pull type” of signal transfer. In the context of the present disclosure, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” and/or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular disclosure, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present disclosure, the term “between” and/or similar terms are understood to include “among” if appropriate for the particular usage and vice-versa. Likewise, in the context of the present disclosure, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, Apple Talk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, Apple Talk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, 4th, and/or 5th generation (2G, 3G, 4G, and/or 5G) cellular technology and/or the like, whether currently known and/or to be later developed. Network access technologies may facilitate wide area coverage for devices, such as computing devices and/or network devices, with varying degrees of mobility, for example.

A network may facilitate radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), IEEE 802.11 (including, but not limited to, IEEE 802.11b/g/n), and/or the like. A wireless network may include virtually any type of now known and/or to be developed wireless communication mechanism and/or wireless communications protocol by which signals may be communicated between devices, between networks, within a network, and/or the like, including the foregoing, of course.

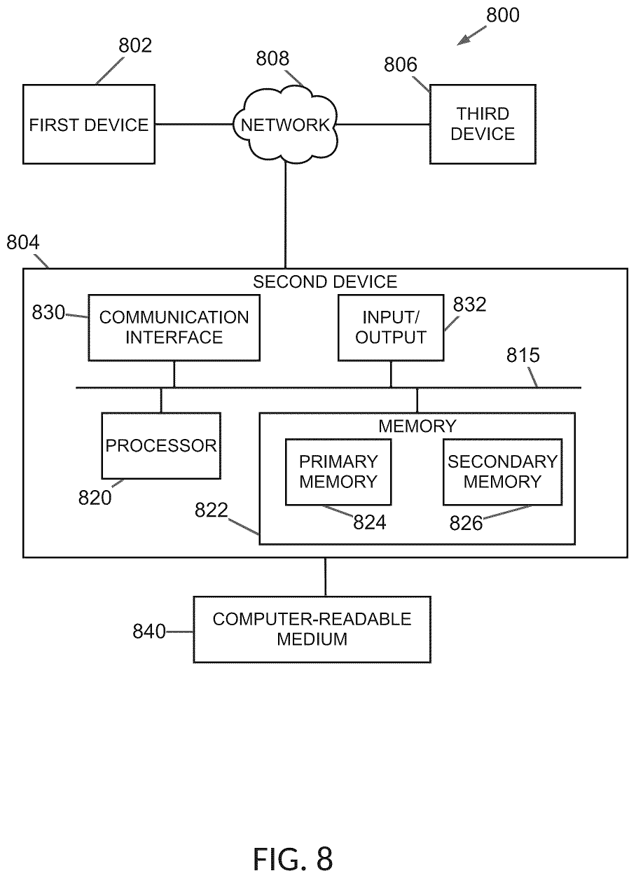

Turning now to FIG. 8, FIG. 8 illustrates an example system embodiment of an network-connected device providing an infrastructure for data management. For example, the illustrated devices and network may be deployed in an example environment such as the example discussed with respect to FIG. 1. In one example embodiment, as shown in FIG. 8, a system embodiment may comprise a local network (e.g., a second device 804 and a computer-readable medium 840) and/or another type of network, such as a computing and/or communications network. For purposes of illustration, therefore, FIG. 8 shows an embodiment 800 of a system that may be employed to implement either type or both types of networks. Network 808 may comprise one or more network connections, links, processes, services, applications, and/or resources to facilitate and/or support communications, such as an exchange of communication signals, for example, between a computing device, such as 802, and another computing device, such as 806, which may, for example, comprise one or more client computing devices and/or one or more server computing device. By way of example, but not limitation, network 808 may comprise wireless and/or wired communication links, telephone and/or telecommunications systems, Wi-Fi networks, Wi-MAX networks, the Internet, a local area network (LAN), a wide area network (WAN), or any combinations thereof. For example, network 808 may a network as described with respect to networks 109 or 110 of FIG. 1.

Example devices in FIG. 8 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present disclosure at least, this is understood to refer to sufficient structure within the meaning of 35 § USC 15 (f) so that it is specifically intended that 35 § USC 15 (f) not be implicated by use of the term “computing device” and/or similar terms; however, if it is determined, for some reason not immediately apparent, that the foregoing understanding cannot stand and that 35 § USC 15 (f) therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1 and 8 of the present disclosure.

Referring now to FIG. 8, in some embodiments, first and third devices 802 and 806 may be capable of rendering a graphical user interface (GUI) for a network device and/or a computing device, for example, so that a user-operator may engage in system use. In other embodiment, first and/or third devices 802 and 806 may operate in a “headless” manner without a GUI. For example, the devices illustrated may be user devices such as devices 102, 103, 104, 105, server devices such as servers 107 as discussed with respect to FIG. 1. Device 804 may potentially serve a similar function in this illustration. Likewise, in FIG. 8, computing device 802 (‘first device’ in figure) may interface with computing device 804 (‘second device’ in figure), which may, for example, also comprise features of a client computing device and/or a server computing device, in an embodiment. Processor (e.g., processing device) 820 and memory 822, which may comprise primary memory 824 and secondary memory 826, may communicate by way of a communication bus 815, for example. The term “computing device,” in the context of the present disclosure, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present disclosure, may comprise hardware, software, firmware, or any combination thereof (other than software per se). Computing device 804, as depicted in FIG. 8, is merely one example, and claimed subject matter is not limited in scope to this particular example.

For one or more embodiments, a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D and/or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable and/or embedded smart card that is able to store subscription content of a user, and/or is also able to store a contact list. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as IOS, Android, Windows Mobile, and/or the like. A computing device and/or network device may include and/or may execute a variety of possible applications, such as a client software application enabling communication with other devices. For example, one or more e-messages (e.g., content) may be communicated, such as via one or more protocols, now known and/or later to be developed, suitable for communication of e-mail, short message service (SMS), and/or multimedia message service (MMS), including via a network, such as a social network, formed at least in part by a portion of a computing and/or communications network, including, but not limited to, Facebook, LinkedIn, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 8, computing device 802 may provide one or more sources of executable computer instructions in the form physical states and/or signals (e.g., stored in memory states), for example. For example, computing device 802 may perform the processes described with respect to FIGS. 2-7. Computing device 802 may communicate with computing device 804 by way of a network connection, such as via network 808, for example. As previously mentioned, a connection, while physical, may not necessarily be tangible. Although computing device 804 of FIG. 8 shows various tangible, physical components, claimed subject matter is not limited to computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 822 may comprise any non-transitory storage mechanism. Memory 822 may comprise, for example, primary memory 824 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 822 may be utilized to store a program of executable computer instructions. For example, processor 820 may fetch executable instructions from memory and proceed to execute the fetched instructions. Memory 822 may also comprise a memory controller for accessing device readable-medium 840 that may carry and/or make accessible digital content, which may include code, and/or instructions, for example, executable by processor 820 and/or some other device, such as a controller, as one example, capable of executing computer instructions, for example. Under direction of processor 820, a non-transitory memory, such as memory cells storing physical states (e.g., memory states), comprising, for example, a program of executable computer instructions, may be executed by processor 820 and able to generate signals to be communicated via a network, for example, as previously described. Generated signals may also be stored in memory, also previously suggested. As example, computer-readable medium 804 may store instructions that, responsive to execution by processor 820, cause the processor to perform or control performance of operations described with respect to FIGS. 2-7.

Memory 822 may store electronic files and/or electronic documents, such as relating to one or more users, and may also comprise a device-readable medium that may carry and/or make accessible content, including code and/or instructions, for example, executable by processor 820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner to form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present disclosure, and generally, is considered to be a self-consistent sequence of operations and/or similar signal processing leading to a desired result. In the context of the present disclosure, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular disclosure, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state and/or thing. For example, but without limitation, for some types of memory devices, a change in state may involve an accumulation and/or storage of charge and/or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 8, processor 820 may comprise one or more circuits, such as digital circuits, to perform at least a portion of a computing procedure and/or process. By way of example, but not limitation, processor 820 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 8 also illustrates device 804 as including a component 832 operable with input/output devices, for example, so that signals and/or states may be appropriately communicated between devices, such as device 804 and an input device and/or device 804 and an output device. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising:
electronically receiving a verification request comprising a verification-type indicator and digital content indicative of an e-message to be verified;
assigning a request ID to the verification request;
initiating a transmission to facilitate a verification process based, at least in part, on the verification-type indicator, the transmission comprising the digital content and the request ID;
receiving a response transmission based, at least in part, on the verification process, the response transmission comprising a verifier entity input regarding the digital content; and
electronically implementing one or more processes based, at least in part, on the response transmission.

2. The method of claim 1, wherein electronically implementing the one or more processes based, at least in part, on the response transmission comprises:
determining a request verification status associated with the request ID based, at least in part, on the verifier entity input.

3. The method of claim 2, wherein electronically implementing the one or more processes based, at least in part, on the response transmission further comprises:
responsive to a positive request verification status determination, initiating a request response transmission to a verification requester entity, the request response indicative of the positive verification status.

4. The method of claim 2, wherein electronically implementing the one or more processes based, at least in part, on the response transmission further comprises:
responsive to a negative request verification status determination:
initiating an alert transmission to a designated entity, the alert transmission comprising the request ID and an indicator of the negative verification status; and
initiating a request response transmission to a verification requester, the request response indicative of the negative verification status.

5. The method of claim 2, wherein electronically implementing the one or more processes based, at least in part, on the response transmission further comprises:
responsive to the negative request verification status determination, initiating an alert message on a designated group messaging channel.

6. The method of claim 1, wherein initiating the transmission to facilitate the verification process based, at least in part, on the verification-type indicator comprises:
responsive to an internal verification-type indicator:
initiating an internal verification transmission to a user identified by the digital content as a sender of the e-message to facilitate an internal verification process; and
receiving a response transmission from the user comprising the verifier entity input, the verifier entity input comprising an agreement or disagreement that the user is the sender of the e-message.

7. The method of claim 1, wherein initiating the transmission to facilitate the verification process based, at least in part, on the verification-type indicator comprises:
responsive to an external verification-type indicator:
performing one or more processing operations to generate an initial assessment of the e-message based, at least in part, on the digital content;
initiating an external verification transmission to facilitate an external verification process, the external verification transmission further comprising the initial assessment; and
receiving a response transmission based, at least in part, on the verification process, the response transmission comprising the verifier entity input regarding the digital content.

8. The method of claim 7, wherein performing the one or more processing operations to generate the initial assessment of the e-message comprises:
performing one or more image information extraction operations on received digital image content;
performing one or more text analysis operations on received digital text content; and
generating the initial assessment based, at least in part, on the one or more image information extraction operations and the one or more text analysis operations.

9. A method, comprising:
receiving a transmission to facilitate a verification process based, at least in part, on a verification-type indicator contained in a request to verify an e-message, the transmission comprising digital content indicative of the e-message and a request ID;
executing the verification process, the verification process including at least an analysis of the digital content and additional information;
receiving verifier entity input indicative of the analysis; and
initiating a response transmission based, at least in part, on the verifier entity input, the response transmission comprising the request ID.

10. The method of claim 9, further comprising retrieving additional information to facilitate the verification process based, at least in part, on the digital content;

11. The method of claim 10, wherein retrieving additional information to facilitate the verification process comprises retrieving a copy of the e-message.

12. The method of claim 9, wherein receiving the transmission comprises receiving an initial assessment of the e-message based, at least in part, on the digital content.

13. The method of claim 9, wherein receiving the transmission to facilitate the verification process comprises an internal verification transmission to a user identified by the digital content as a sender of the e-message to facilitate an internal verification process.

14. The method of claim 13, wherein initiating the response transmission based, at least in part, on the verifier entity input comprises initiating the response transmission by the user, the verifier entity input comprising an agreement or disagreement that the user is the sender of the e-message.

15. The method of claim 9, wherein receiving the transmission to facilitate the verification process comprises an external verification transmission to facilitate an external verification process by an external, non-user verifier entity, the external verification transmission further comprising an initial assessment of the e-message.

16. The method of claim 15, wherein initiating the response transmission based, at least in part, on the verifier entity input comprises initiating the response transmission by the non-user verifier, the response transmission including the verifier entity input indicative of the analysis of the digital content.

17. A non-transitory computer-readable medium having instructions stored thereon that, responsive to execution by a computing system, cause the computing system to perform or control performance of operations that comprise:
receiving a verification request comprising a verification-type indicator and digital content indicative of an e-message to be verified;
assigning a request ID to the verification request;
initiating a transmission to facilitate a verification process based, at least in part, on the verification-type indicator, the transmission comprising the digital content and the request ID;
receiving a response transmission based, at least in part, on the verification process, the response transmission comprising a verifier entity input regarding the digital content; and
electronically implementing one or more processes based, at least in part, on the response transmission.

18. The non-transitory computer-readable medium of claim 17, wherein electronically implementing the one or more processes based, at least in part, on the response transmission comprises:
determining a request verification status associated with the request ID based, at least in part, on the verifier entity input.

19. The non-transitory computer-readable medium of claim 18, wherein electronically implementing the one or more processes based, at least in part, on the response transmission further comprises:
responsive to a positive request verification status determination, initiating a request response transmission to a verification requester, the request response indicative of the positive verification status.

20. The non-transitory computer-readable medium of claim 18, wherein electronically implementing the one or more processes based, at least in part, on the response transmission further comprises:
responsive to a negative request verification status determination:
initiating an alert transmission to a designated entity, the alert transmission comprising the request ID and an indicator of the negative verification status; and
initiating a request response transmission to a verification requester, the request response indicative of the negative verification status.

21. The non-transitory computer-readable medium of claim 20, wherein electronically implementing the one or more processes based, at least in part, on the response transmission further comprises:
responsive to the negative request verification status determination, initiating an alert message on a designated group messaging channel.

22. The non-transitory computer-readable medium of claim 17, wherein initiating the transmission to facilitate the verification process based, at least in part, on the verification-type indicator comprises:
responsive to an internal verification-type indicator:
initiating an internal verification transmission to a user identified by the digital content as a sender of the e-message to facilitate an internal verification process; and
receiving a response transmission from the user comprising the verifier entity input, the verifier entity input comprising an agreement or disagreement that the user is the sender of the e-message.

23. The non-transitory computer-readable medium of claim 17, wherein initiating the transmission to facilitate the verification process based, at least in part, on the verification-type indicator comprises:
responsive to an external verification-type indicator:
performing one or more processing operations to generate an initial assessment of the e-message based, at least in part, on the digital content;
initiating an external verification transmission to facilitate an external verification process, the external verification transmission further comprising the initial assessment; and
receiving a response transmission based, at least in part, on the verification process, the response transmission comprising the verifier entity input regarding the digital content.

24. The non-transitory computer-readable medium of claim 23, wherein performing the one or more processing operations to generate the initial assessment of the e-message comprises:
performing one or more image information extraction operations on received digital image content;
performing one or more text analysis operations on received digital text content; and
generating the initial assessment based, at least in part, on the one or more image information extraction operations and the one or more text analysis operations.
